(19) United States
(12) Patent Application Publication
(10) Pub. No.: US 2023/0306255 A1
(43) Pub. Date: Sep. 28, 2023

(54) METHOD AND SYSTEM FOR SMOOTH TRAINING OF A QUANTIZED NEURAL NETWORK

(71) Applicants: Ella CHARLAIX, Montreal (CA); Vanessa COURVILLE, Montreal (CA); Vahid Partovi Nia, Montreal (CA)

(72) Inventors: Ella CHARLAIX, Montreal (CA); Vanessa COURVILLE, Montreal (CA); Vahid Partovi Nia, Montreal (CA)

(21) Appl. No.: 17/701,257

(22) Filed: Mar. 22, 2022

(51) Int. Cl. G06N 3/08

(52) U.S. Cl. CPC G06N 3/08

(57) ABSTRACT

Training a neural network, including applying a quantization function to a set of real-valued weights to generate quantized weights scaled to fall within a respective quantization range that is symmetrically centered at zero and comprises a defined number of uniform quantization levels corresponding to integer multiples of a scaling factor. A cost is computed based alignments of the quantized weights with the quantization levels. The real-valued weights and the scaling factor are adjusted with an objective of reducing the computed cost in one or more following training iterations. When performing a plurality training iterations, a smoothness of the quantization function is incrementally reduced for multiple training iterations. Alignment of quantized weights with quantization levels and decreasing smoothness of the quantization function can result in a trained neural network that can perform accurate predictions using relatively few computational resources.

### CROSS-REFERENCE TO RELATED APPLICATIONS

This is the first application related to the present disclosure.

### FIELD

This disclosure relates generally to artificial neural networks. More particularly, the present application relates to smooth training of a neural network that includes a computational block having quantized inputs and parameters.

### BACKGROUND

Artificial neural networks (NNs) are computing systems that are modeled on how biological brains operate. NNs are made up of a number of layers (e.g., computational blocks) that each include a plurality of computational units (called neurons), with connections among computational units of different layers. Each computational unit in a NN transforms data using a series of computations that include each respective computational unit multiplying an initial value by some weight, summing the results with other values coming into the same respective computational unit, adjusting the resulting number by the respective bias of the computational unit, and then normalizing the output with an activation function. The bias is a number which adjusts the value of a respective computational unit once all the connections are processed, and the activation function ensures values that are passed on to a subsequent computational unit within a tunable, expected range. The series of computations is repeated until a final output layer of the NN generates scores or predictions related to a particular inference task. NNs can learn to perform inference tasks, such as object detection, image classification, clustering, voice recognition, or pattern recognition. NNs typically do not need to be programmed with any task-specific rules. Instead, NNs generally perform supervised learning tasks, building knowledge from data sets where the right answer is provided in advance. NNs then learn by tuning themselves to find the right answer on their own, increasing the accuracy of their predictions.

NNs have become larger (i.e., deeper) and more complicated. This has inevitably increased the number and size of layers in the NN to the point where it can be costly to implement the NN in software or hardware. NNs increasingly rely on usage of specially designed, computationally powerful hardware devices that include one or more processing units, accelerators (e.g., accelerators designed to perform certain operations of the NN) and supporting memory to perform the operations of each of the layers of the NN (hereinafter referred to generally as NN operations and individually as NN operation). In some examples, a dedicated processing unit, accelerator and supporting memory are packaged in a single integrated circuit. The computationally powerful hardware devices required for executing NN operations of deep NNs come with increased financial cost, as well as ancillary costs in terms of physical space and thermal cooling requirements.

Deep NNs are commonly full precision NN's constructed using full-precision layers that are made up of full-precision computational units. Full-precision layers perform NN operations, such as a matrix multiplication, addition, batch normalization, and multiply-accumulate (MAC) in respect of values that each have more than 8 bits (e.g., the individual elements in a feature tensor such as a input feature vector or feature map are each real values represented using 8 or more bits, and the network layer parameters such as weights included in a weight tensor are also real values represented using 8 or more bits). NN operations performed in the context of a full precision layer are referred to as high-bit NN operations. In particular, each element output of a computational unit in a layer of NN (e.g., i^{th} layer of NN) is a weighted sum of all the feature elements input to the computational unit, which requires a large number of multiply-accumulate (MAC) operations per full-precision layer. Accordingly, the high-bit NN operations performed by a full-precision NN layer are computationally intensive. This places constraints on the use of full-precision NN's in computationally constrained hardware devices (e.g. micro-controllers used in resource constrained devices such as IoT devices, mobile devices and other edge devices).

Accordingly, in order to address challenges related to energy and power consumption, latency, storage and memory bandwidth there is a growing interest in NN model compression techniques that may reduce the number of, and/or or complexity of, NN operations performed by a NN configured for a particular inference task. NN model compression can enable NNs to be deployed in computationally constrained hardware devices that may for example employ less powerful processing units, less powerful (or no) accelerators, less memory and/or less power than required for deployment of a non-compressed NN. NN model compression techniques may for example be applied in cost-effective computationally constrained hardware devices that can be implemented to solve real-world problems in applications such as robotics, autonomous driving, drones, and the internet of things (IOT). Neural network quantization is one NN compression technique being adopted to address the challenge of compressing a trained NN to enable NN operations to be performed on resource-constrained hardware device. Among other things, NN quantization may be used to replace high-bit MAC operations performed at an NN layer with low-bit operations performed on values that have fewer than 8 bits, for example 4-bit values (also referred to as quaternary values).

Low-bit neural network quantization techniques can generally be classified into two different categories: (i) weight quantization techniques that quantize the real-valued weight tensor received by a NN layer but use real-valued feature tensors (or activations) in the NN operations of the NN layer; and (ii) weight and feature map quantization techniques that quantize both real-valued weight tensor and activations.

Various quantization solutions have been proposed, however training using such solutions can lead to inaccurate NNs. There is a need for a training method and system that can improve hardware efficiency while also maintaining accuracy at an acceptable level.

### SUMMARY

The present disclosure provides methods and systems for smooth training of a neural network that includes a computational block having quantized inputs and weights.

According to a first aspect of the disclosure, a method of training a neural network that comprises a plurality of computational blocks is disclosed. The method includes performing a plurality of training iterations. Each training iteration includes: (i) for each computational block: (a) applying a respective quantization function to a set of respective real-valued weights of the computational block to generate a respective set of quantized weights that are scaled based on a respective scaling factor to fall within a respective quantization range that is symmetrically centered at zero and comprises a defined number of uniform quantization levels corresponding to integer multiples of the respective scaling factor; and (b) computing a set of respective output activations for the computational block based on a respective set of input activations and the respective set of quantized weights; and (ii) computing a cost for the training iteration based on the respective output activations of the computational blocks and relative alignments of the respective quantized weights of the computational blocks with the uniform quantization levels of the respective quantization ranges; and (iii) for each computational block, adjusting the set of respective real-valued weights and the respective scaling factor with an objective of reducing the computed cost in one or more following training iterations. When performing the plurality of training iterations, a smoothness of the respective quantization functions applied by the computational blocks is incrementally reduced for multiple training iterations of the plurality of training iterations.

In at least some examples, constrained quantization can result in a trained NN that can exploit hardware efficiency due to the uniform symmetric quantization, while maintaining accuracy. Further, an incremental quantization process can, in at least some scenarios, mitigate against destabilization that can result from too rapid quantization.

In some examples of the preceding aspect, the method includes for each training iteration, computing the cost comprises applying a scaling factor regularization function to output regularization cost values based on the respective quantized weights and the respective scaling factors, the scaling factor regularization function being configured to generate a regularization cost value that decreases the closer that the respective quantized weights each align with one of the uniform quantization levels.

In some examples of one or more of the preceding aspects, the neural network comprises an input block prior to the plurality of computational blocks, and an output block following the plurality of computational blocks, the input block, plurality of computational blocks, and output block arranged as respective layers of the neural network to collectively process input feature tensors received at the input block representing objects and output, from the output block, respective predictions for the objects, and wherein, for each training iteration, the respective set of input activations for each of the plurality of computational blocks following a first computational block is the set of output activations computed by a preceding computation block of the plurality of computational blocks, and each training iteration comprises, for each computational block, applying a respective activation quantization function to the respective set of respective set of input activations to generate a respective set of quantized activations, wherein for each computational block, computing the set of respective output activations for the computational block is based on a matrix multiplication of the respective set of quantized activations and the respective set of quantized weights for the computational block; wherein, for each training iteration, computing the cost comprises computing an error between the respective predictions for the objects and expected values for the objects.

In some examples of one or more of the preceding aspects, for each computational block, applying the respective activation quantization function generates the respective set of quantized activations scaled within a respective activation quantization range that is symmetrically centered at zero and comprises a defined number of uniform activation quantization levels.

In some examples of one or more of the preceding aspects, the computational blocks include at least one computational block that implements one of a fully connected neural network layer or a convolution neural network layer.

In some examples of one or more of the preceding aspects, for each computational block, the respective quantization function is a piecewise function comprising a plurality of repeated, shifted functions that each correspond to a respective uniform quantization level, and wherein incrementally reducing the smoothness of the respective quantization functions comprises incrementally increasing a slope of the function.

In some examples of one or more of the preceding aspects, the set of respective real-valued weights and the respective scaling factor for each computational block is performed using a derivative of a corresponding one of the plurality of repeated, shifted functions for at least some of the plurality of training iterations.

In some examples of one or more of the preceding aspects, incrementally reducing the smoothness of the respective quantization functions is performed in a linear manner across at least a first group of the plurality of training iterations and is suspended when a predetermined criteria is reached, following which a quantization function of constant smoothness is used as the respective quantization functions for a remainder of the plurality of training iterations. In some examples of one or more of the preceding aspects, the defined number of uniform quantization levels is 15.

In some examples of one or more of the preceding aspects the method comprises storing, for each of the computational blocks, a quantized weights version of the adjusted set of respective real-valued weights at a completion of the plurality of training iterations, and deploying a trained version of the neural network that includes the quantized weights version for each of the computational blocks.

According to a further example aspect, a processing unit is disclosed. The processing unit includes one or more processing devices and one or more storages operatively connected to the one or more processing devices and storing executable instructions that when executed by the one or more processing devices configure the processing unit to perform on or more of the methods of the preceding aspects.

According to a further example aspect, a computer readable medium is disclosed that stores executable instructions that when executed by one or more processing devices configures the processing device(s) to perform on or more of the methods of the preceding aspects.

### BRIEF DESCRIPTION OF THE DRAWINGS

Reference will now be made, by way of example, to the accompanying drawings which show example embodiments of the present application, and in which:

FIGS. 1A and 1B illustrate example of uniform quantization ranges;

FIG. 2 illustrates a neural network having a computational block in accordance with example embodiments;

FIG. 3 is a schematic representation of a quantization operation of the computational block of FIG. 2;

FIG. 4A illustrates a plot of a regularization function with a first scaling value;

FIG. 4B illustrates a plot of the regularization function with a second scaling value;

FIG. 5A illustrates a plot of a quantization function with a first slope variable value;

FIG. 5B illustrates a plot of the quantization function with a second slope variable value;

FIG. 5C illustrates a plot of the quantization function with a third slope variable value;

FIG. 5D illustrates a plot of the quantization function with a fourth slope variable value;

FIG. 6 illustrates a trained and deployable version of a neural network with a computational block, in accordance with example embodiments;

FIG. 7 is a flow diagram illustrating a method of training an NN according to examples of the disclosure; and

FIG. 8 is a block diagram illustrating an example processing system that may be used to execute machine readable instructions of an NN that includes one or more computational blocks shown in FIG. 2 or FIG. 6.

Similar reference numerals may have been used in different figures to denote similar components.

### DESCRIPTION OF EXAMPLE EMBODIMENTS

The present disclosure is directed to training a quantized neural network (NN) that includes one or more layers implemented using respective computational blocks. The disclosed methods and systems can, in at least some scenarios, strive to maximize hardware efficiency while maintaining prediction accuracy. In example aspects, the balance is achieved during training of the NN by estimating an optimal quantization range and step size and also slowly guiding the NN toward its quantized version to reduce destabilization that can otherwise result from abrupt quantization.

As used herein, “tensor” or “array” refers to an ordered set of elements where the order of the elements has meaning, such as a vector (e.g., a one-dimensional array such as a row array or column array that includes multiple scaler feature elements) or a matrix or a map (e.g., a multi-dimensional array, with each dimension including multiple elements).

“Feature tensor” refers to an array of elements that represent features of an object that is being processed. For example, the object being processed could be an instance of image data, audio data, numerical data, or other form of structured or unstructured data that is represented as a feature tensor that provided as input to an NN.

“Activations” refers to an array of elements that are output by a computational block (i.e. a layer) of an NN, representing the object being processed. In a deep NN, the activations output by one computational block are used as the inputs to a subsequent computational block.

“Weights” refers to an array of weight elements, such as a weight vector (e.g., a one-dimensional array such a row array or column array that includes multiple weight elements) or a weight matrix (e.g., a multi-dimensional array, with each dimension including multiple scaler weight elements).

In example embodiments, a “low-bit element” refers to an element that is represented using less than 8 bits. In at least some embodiments, a trained NN that includes one or more of the disclosed computational blocks may be deployed for execution by a computationally constrained hardware device (e.g., a device that has one or more of limited processing power, limited memory, or limited power supply). A NN that includes the computational blocks as described in the present disclosure may, in at least some applications, perform an inference task, in a manner that precisely approximates the performance of a full-precision NN, and thus mitigate conventional problems such as extensive use of MAC operations and/or decreased accuracy that may arise when existing bitwise NN structures are used to provide a discrete approximation of full-precision NNs.

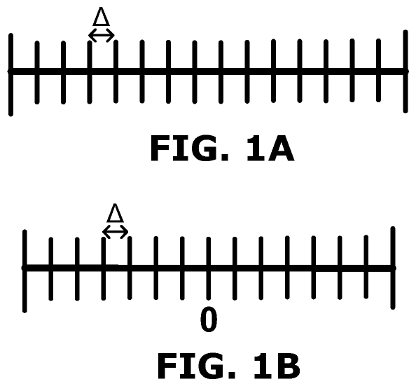

A summary of uniform quantization will be provided, with reference to FIGS. 1A and 1B, to provide context for the following disclosure. Uniform quantization is a process in which an input value is mapped to one of a plurality of discrete quantization levels that fall within a defined uniform quantization range, illustrated for example in FIG. 1A. Uniform means that the difference between two adjacent quantized levels (i.e., step size A) is constant.

The multiplication between integer valued quantized weights Q_{w} and quantized activations Qₐ, rescaled back to an original magnitude, can be represented by Equation 1:

(s_{w}Q_{w}+t_{w})·(sₐQₐ+tₐ)=s_{w}sₐQ_{w}Qₐ+tₐs_{w}Q_{w}+t_{w}sₐQₐ+t_{w}tₐ (EQ. 1)

Where: s_{w} and t_{w} are full precision scaling and offset weight values, respectively; and sₐ and tₐ are full precision scaling and offset activation values, respectively.

The presence of full precision values along with quantized values in Equation 1 increases computational overheard, and accordingly is not optimal for computationally limited devices.

In some quantizing solutions, a zero can be perfectly representable in the quantized range if the zero value is a quantization level. If a quantization range is uniform and has a perfectly representable zero, all quantization levels are a multiple of the step size defining the uniform range, and the above multiplication equation can be simplified, resulting in a more efficient computation, as shown in Equation 2:

s_{w}(Q_{w}−Z_{w})·sₐ(Qₐ−Zₐ)=s_{w}sₐ(Q_{w}Qₐ−ZₐQ_{w}−Z_{w}Qₐ+Z_{w}Zₐ) (EQ. 2)

Where Zw is a zero correction term for the quantized weights Q_{w} and Za is a zero correction term for the quantized activations Qₐ.

A case where the quantization range is uniform and symmetrical around zero, as illustrated in FIG. 1B, has by definition a representable zero value. If the quantization range for the weights is uniform and symmetric, the value of Z_{w} (i.e., the zero correction term for the quantized weights Q_{w}) is zero, resulting in the suppression of two terms in Equation 2, allowing a more efficient computation that can reduce the number of operations that must be done in the hardware, reducing latency and improving power efficiency, as represented in the following Equation 3:

s_{w}(Q_{w})·sₐ(Qₐ−_{Za})=s_{w}sₐ(Q_{w}Qₐ−ZₐQ_{w}) (EQ 3)

Accordingly, the use of a uniform and symmetric quantization range can improve hardware efficiency. However, shifting between a real value domain and a quantized integer domain when learning quantized weights for an NN can result in errors in both the endpoints of the quantization range and the step size. Furthermore, abrupt quantization during training iterations can result in destabilization that can lead to inaccuracies in the trained NN. As noted above, the disclosed methods and systems strive to maximize hardware efficiency while maintaining prediction accuracy. As will be explained in greater detail below, this balance can, in at least some use cases, be achieved during training of the NN by applying regularized quantization to estimate an optimal quantization range and scaling value for the weight tensor. Furthermore, a quantization function can be approximated by a smoother version during NN training for forward passes and the derivative of the approximated version used during backward passes (instead of an approximation such as a Straight-Through Estimator (STE)), to allow the NN to be slowly guided to a quantized version and avoid gradient mismatch.

Computational Block

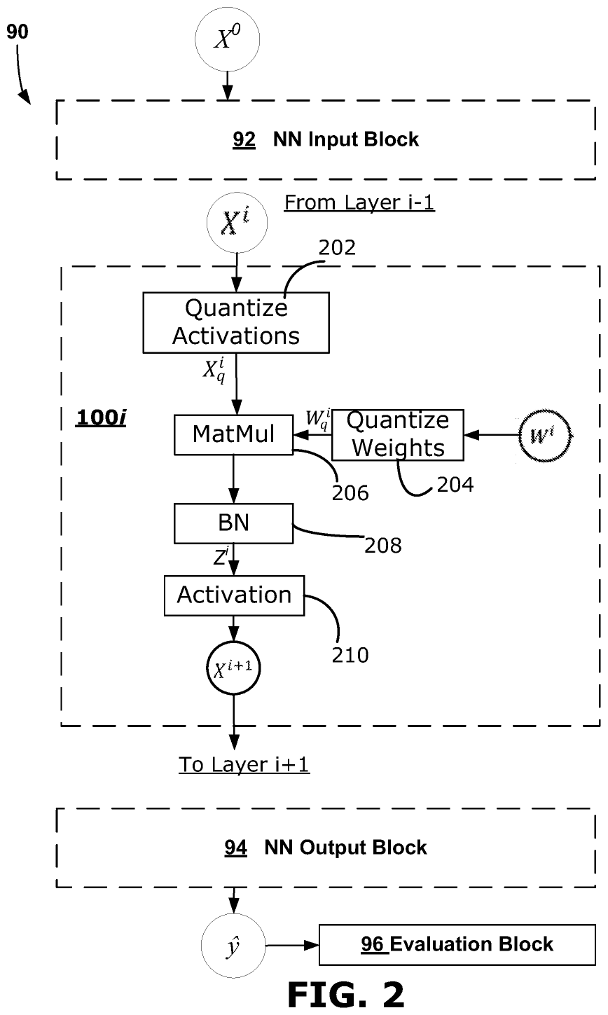

FIG. 2 is a representation of a deep NN 90 that includes a plurality of successive quantized computational blocks 100i. Each computational block 100i can be used to implement a respective hidden layer of a deep NN 90 during a training stage, according to example embodiments. NN 90 can include an input block 92 (i.e., an input layer), followed by multiple successive computational blocks 100i, where i={1, . . . , n}, and an output block 94 (i.e., an output layer). In the presently described embodiment, computational block 100i represents an hidden layer of NN 90. The NN 90 is trained to perform a prediction task for an input object, which may for example be represented by an input feature tensor X°. For example, the prediction task may be to classify the input object as falling within a particular category from a set of candidate categories. Computational block 100i can, for example, be configured as a fully connected NN layer or as a convolution NN layer.

Training NN 90 includes performing a series of training iterations that each include a forward pass and a backward pass. During each forward pass, a respective batch of one or more training samples from a training dataset are provided to the NN 90 to generate respective predictions for each of the training samples. At the end of each forward pass, a cost (also referred to as a loss) is computed by an evaluation block 96 that includes an error value indicating a difference between the predictions that are output by the NN 90 for the training samples and expected outputs (e.g., target values or ground truth labels). The cost can be calculated using a defined cost function (also referred to as a loss function). During each backward pass a backpropagation algorithm is applied to update trainable parameters (e.g., NN weights and biases) of the NN 90 with an objective of minimizing the cost in future iterations. For example, a backpropagation algorithm can be applied to calculate the gradient of the cost function at the NN output block 94 and then distribute this gradient back through the computational blocks 100i to adjust the learnable parameters, including weights W′, of each computational blocks 100i. Multiple batch-based training iterations can be required to process an entire training dataset as part of a single training epoch. Multiple training epochs can be required to ultimately train the NN 90.

During a forward pass of a training operation, a batch of one or more input feature tensors that each correspond to a respective training sample and represent a respective object are successively provided to NN 90. The processing of a single input feature tensor X⁰ is as follows: input feature tensor X⁰ is provided to an input block 92 (e.g., an input layer) of the NN 90 to provide an initial set of activations X¹ as input to an initial computational block 100ᵢ₌₁. The input to an i^{th} computational block 100i is the set of activations X′ generated by a preceding computational block. In the present disclosure, uppercase letters (e.g., “X”, “W”, “Z”) are used to represent tensors (e.g., multi-element vectors or arrays) and lowercase letters (e.g., “x”, “w”, “z”) are used to represent individual elements that make up a tensor.

Each computational block 100i is configured to perform a set of operations to process its input activations X′ and generate corresponding output activations Xⁱ⁺¹. The operations performed by computational block 100i can include operations commonly found in an NN layer, namely, a matrix multiplication operation (MatMul) 206 (which can, for example, include multiply and accumulate operations), a batch normalization (BN) operation 208, and an activation function 210. Further, in the illustrated example, the training stage computational block 100i includes a quantize activations operation 202 and a quantize weights operation 204 for respectively quantizing activations Xⁱ and weights Wⁱ.

Quantized activations X_{q}ⁱ are provided to the matrix multiplication operation (MatMul) 206. Matrix multiplication operation (MatMul) 206 performs a multiplication and accumulation operation between quantized weights W_{q}ⁱ and the quantized activations X_{q}ⁱ to generate an intermediate output tensor that is provided to the BN operation 208. BN operation 208 can be implemented according to known batch normalization techniques.

BN operation 208 outputs a real-valued feature tensor Zⁱ which is provided to the activation function 210, which may for example be implemented using a rectified linear unit (ReLU) or other suitable non-linear activation function. Activation function 210 generates the output of computational block 100i, namely a set of real-valued activations Xⁱ⁺¹

The set of real-valued activations X^{i=final} from a final hidden computational block are passed to output block 94 which generates a prediction ŷ in respect of input feature tensor X° set. By way of example, output block 94 can include a Softmax layer that generates a vector that includes a respective probability value for each possible output category, with the category having the highest probability representing the prediction ŷ.

At the completion of a forward pass, all the predictions ŷ generated for the batch are evaluated are evaluated by evaluation block 96, which applies a cost function to calculate a cost based at least in part on a prediction error that indicates a difference between the predictions and the expected or target outputs. During the backward pass, as noted above, a backpropagation algorithm is applied to adjust the parameters (e.g., weights Wⁱ) of each of the respective computational blocks 100i, with an objective of reducing the cost in future training iterations. Upon the completion of training, a trained NN can be deployed that is parameterized with the final quantized weights W_{q}ⁱ for all compultational blocks 100i, i={1, . . . , n}.

Regularized and Constrained Quantization

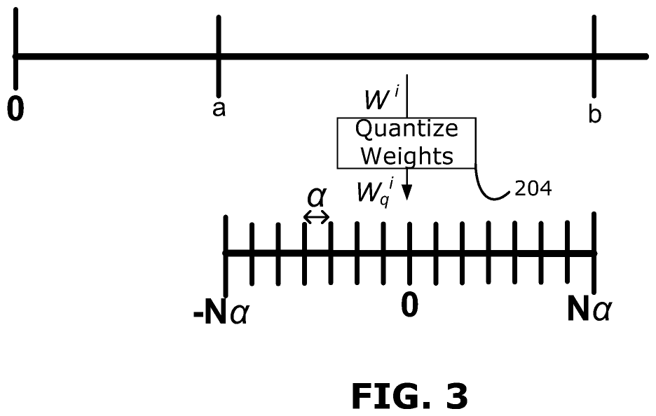

In example embodiments, when training NN 90, a respective scaling factor α (also referred to as step size) and a zero-centered quantization range [−Nα, Nα] are also learned for each computational block 100i. As illustrated in FIG. 3, quantize weights operation 204 is trained to constrain the quantized weights W_{q}ⁱ in a range symmetrically centered at 0. As noted above, symmetrically quantized weights can enable fewer computations to be required in a trained NN. The number of quantization levels M (i.e., the number of available quantization values) associated with k-bit quantization is 2^{k}−1 for a symmetric domain. Thus, in the example of k=4 bit quantization, a real-valued weight w included in weights W′ will be mapped to one a quantized weight w_{q} that will have one of 15 discrete values. The values of quantized weights W_{q}ⁱ are thus constrained to be in the range of [−Nα, Nα], where N is a constant equal to 2^{k-1}−1 (e.g., N=7, in the case of k=4). The scaling factor α defines the step size between two adjacent quantized values. The range [−Nα, Nα] acts as a threshold on the weights W′ and enables a trade-off between precession on high magnitude values and resolution on values inside the domain of range [−Nα, Nα]. For example, a smaller scaling factor α will result in higher resolution but a smaller range [−Nα, Nα]. Any weight w_{q} that has a value of greater than or equal to Nα will be set to a quantized value of Na, and any weight w_{q} that has a value of less than or equal to z-Nα will be set to a quantized value of −Nα. During training, the scaling factor α will adjust to enable the highest and lowest value weights within the range of weights included in the weights Wⁱ to be represented in the range [−Nα, Nα]. A respective scaling factor α is learned for each computational block 100i, thereby enabling optimized and individualized weight quantization for each NN layer.

In example embodiments, a regularization function that outputs a regularization cost value based on the scaling factor α is included in the cost function that is used to train NN 90. The scaling factor regularization function is configured to push the weights W′ of computational block 100i to respective quantized values that are a closest multiple of scaling factor α. In this regard, the scaling factor regulation function is configured to generate a regularization cost value that decreases the closer that the respective quantized weights each align with one of the uniform quantization levels.

By way of example, the cost function applied by evaluation block 96 can be represented as:

Cost=Error (Y,Ŷ)+(L1 or L2 Regularization Function)+R(W|α) (EQ. 4)

Where: Error (Y,Ŷ) can be any suitable function for computing an error value that represents a difference between predictions Ŷ (output by NN 90 and target values Y (e.g., cross entropy loss or Mean Square Error); L1 or L2 refer to the L1 and L2 regularization functions respectively; and R(W|α) refers to a scaling factor regulation function.

Different functions may be used in different embodiments to implement scaling factor regulation function R(W|α) to push the respective weights to quantized values that are a closest multiple of scaling factor α. In example embodiments, the scaling factor regulation function R(W|α) provides a set of constraining cavities equal in number to the number of quantization levels M, with the regulation function R(W|α) having a value of zero for every quantized weight such as R(jα)=0 for {j∈ [symbol] , |−N≤j≤N, and a positive value for all other values (e.g., the cavities have a zero value at each of the M quantization levels). For example, a sinusoidal function such as

$$R ( w \vert α ) = {sin}^{2} ( \frac{π * w}{α} )$$

can be used, where w indicates a single weight in weights W.

In a further illustrative example, the following function is used to implement regulation function R(W|α):

R(w|α)=f⁻²⁺²^{^{k}}(w|α)^{P}·2^{P} (EQ. 4)

Where:

$$f ( w \vert α ) = \vert x - \frac{α}{2} \vert ,$$

and 2^{P} is a hyper-parameter coefficient used to rescale the weights for a computational block during a backward pass.

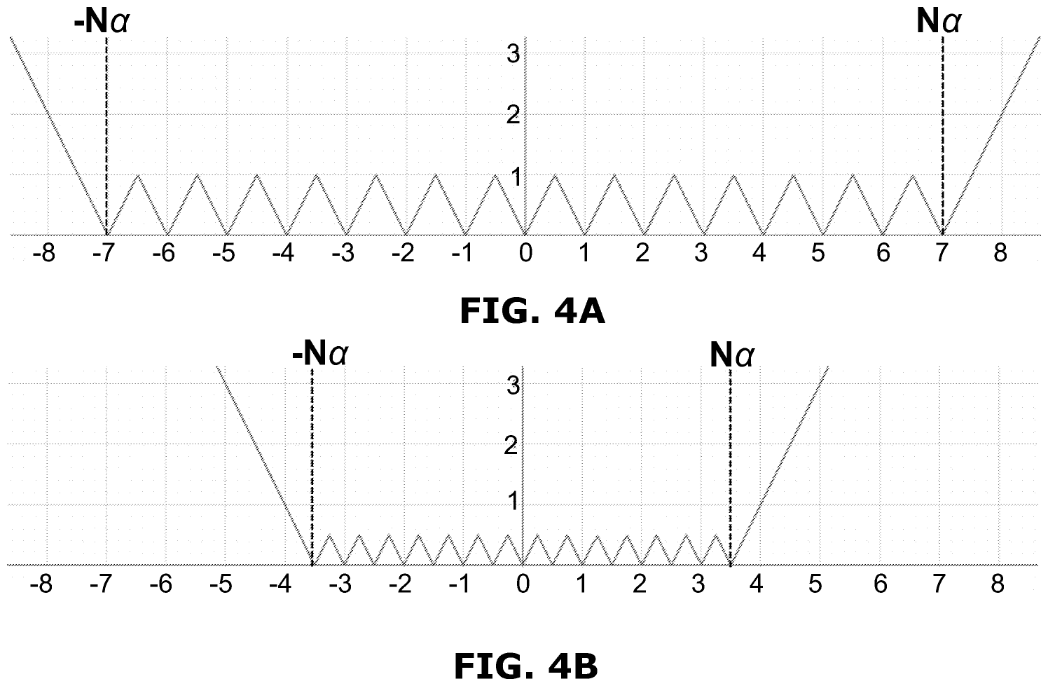

FIG. 4A shows an example for the regularization function of EQ. 4 with k=4, p=1, N=7 and α=1. FIG. 4B shows an example for the regularization function of EQ. 4 with p=1, N=7 and α=0.5.

As shown in FIGS. 4A and 4B, the quantized weight range [−Nα, Nα] is constrained to be symmetrically centered at 0, with N=2k−1−1 (e.g., [−7α,7α] for 4-bit quantization). The quantized values are defined by ja with {j∈ [symbol] , |−N≤j≤N}. Every value outside the range [−Nα, Nα] is be clamped to either −Nα (if the value is less than −Nα) or Nα (if the value is greater than Nα).

In at least some examples, this constrained quantization can result in a trained NN that can exploit hardware efficiency due to the uniform symmetric quantization, while maintaining accuracy. Accuracy is maintained by guiding the real-valued weights towards their quantized counterparts by using a regularization function. Furthermore, for each computational block 100i the quantization range is adaptive (defined by the trainable scaling factor α for the computational block 100i), which can reduce errors induced by quantization.

In some examples, respective activation scaling values and quantization ranges can also be learned using similar methods for the quantize activations operation 202 performed at each computational block 100i, based on an assumption that the actual objects being classified by a deployed version of NN 90 will have activations that fall within similar ranges as the objects used during training. As the objects change during deployment, the deployed version of NN 90 will still require a quantize activations operation 202 to be performed at each computational block 100i, however the scaling factor and activation range of the quantize activations operation 202 can be learned using the methodology discussed above.

Gradual Quantization

Rapid quantization of weights and activations while training can cause destabilization of an NN. However, a significant drop in accuracy can result when quantization is delayed until after a defined number of iterations. On the other hand, quantizing at the beginning of training is not always the best solution as the NN can quickly converge towards a suboptimal solution. According to aspects of the present disclosure, this negative effect can be attenuated by replacing a true quantization function (for example a step function) by a smoother quantization function for at least an initial training period. Such a solution can slowly guide the NN toward its quantized variant, thus preventing an abrupt quantization which could destabilize the NN. As used in this disclosure, the smoothness of a function corresponds to the steepest slope of the function, i.e., the highest change in the quantized value versus a change in the non-quantized value with the domain of the function. By way of example, the steepest slope in a step function is infinity; the steepest slope in a unitary linear function is 1, such that a unitary linear function is infinitely smoother than a step function.

Accordingly, as noted above, in example embodiments, during NN training, the quantization functions applied by quantize activations operation 202 and quantize weights operation 204 can be approximated by a smoother quantization function version during forward passes and the derivative of the smoother version used during backward passes (instead of an approximation such as a Straight-Through Estimator (STE)), to allow the NN to be slowly guided to a quantized version and avoid gradient mismatch.

In example aspects, the quantize activations operation 202 and quantize weights operation 204 each apply respective piecewise quantization functions. In one example, a respective piecewise combination of shifted, repeated tan h functions (one shift for each quantization level) is used to implement each of quantize activations operation 202 and quantize weights operation 204, with the steepness of the slopes of the repeated tan h functions increasing as the number of iterations grows. In an alternative example, a respective piecewise combination of shifted, repeated logistic functions (one shift for each quantization level) is used to implement quantize activations operation 202 and quantize weights operation 204, with the steepness of the slopes repeated logistic functions increasing as the number of iterations grows. Thus, the

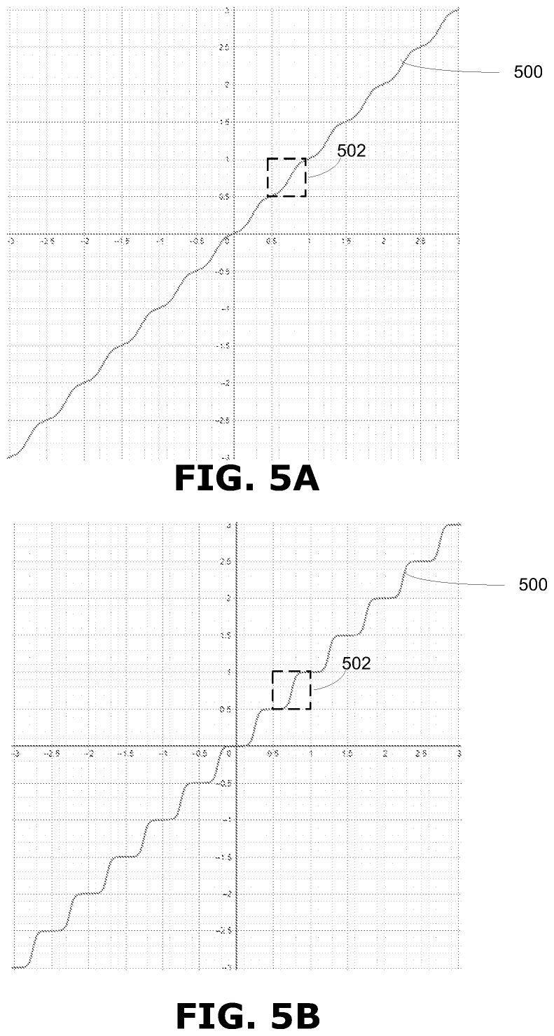

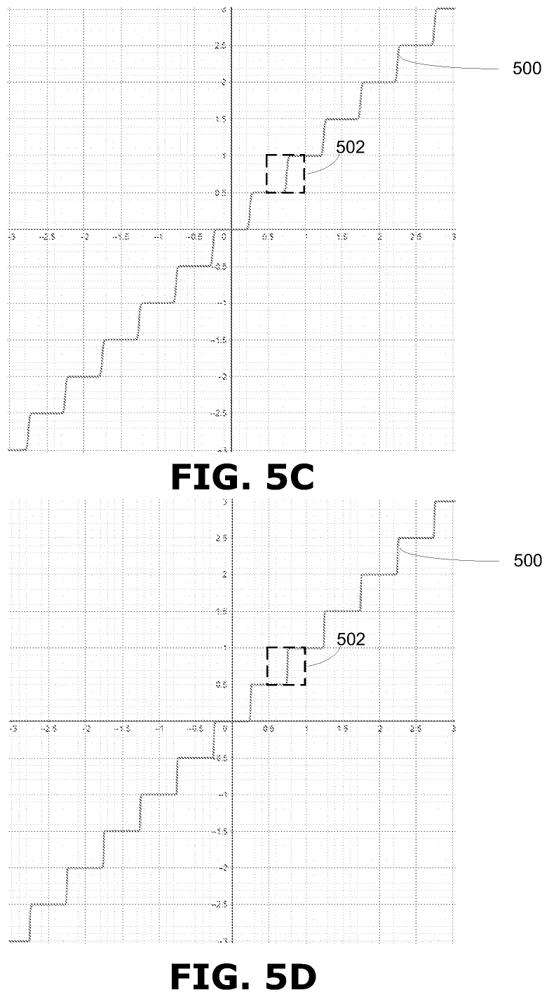

By way of example, FIGS. 5A to 5D represent an example of the evolution of a piecewise logistic quantization function 500 that can be used to implement either quantize activations operation 202 and quantize weights operation 204 during forward pass training iterations of NN 90. Piecewise logistic quantization function 500 is formed from a set of repeated, shifted logistic functions 502, where the slope of logistic function 502 gradually increases during training iterations. Each logistic function 502 has a respective domain that corresponds to one scaling factor α. In an example embodiment, the slope of logistic function 502 is controlled by a slope variable β, where β=1 corresponds to a direct linear mapping of an input value to an output value and β=00 corresponds to a perfect step function (i.e., a true quantization function). The derivative of the logistic function 502 is used for updating weights during backward passes. As the true derivative of the function is used rather than an approximation, problems with gradient mismatch can be mitigated.

FIG. 5A illustrates an example of logistic quantization function 500 with scaling factor α=0.5 and slope variable β=4. FIG. 5B illustrates an example of logistic quantization function 500 with scaling factor α=0.5 and slope variable β=6.5. FIG. 5C illustrates an example of logistic quantization function 500 with scaling factor α=0.5 and slope variable β=27. FIG. 5D illustrates an example of logistic quantization function 500 with scaling factor α=0.5 and slope variable β=80.

Accordingly, in example embodiments, the smoothness of the individual logistic functions 502 that form piecewise logistic quantization function 500 is incrementally decreased in multiple training iterations of the plurality of training iterations FIGS. 5A to 5D.

In example embodiments the value of slope variable β for all quantize activations operations 202 and quantize weights operations 204 is increased linearly as the number of training iterations increases, resulting in a linear decrease in quantization function smoothness as the number of training iterations increases. In some examples, once a predetermined criteria is achieved (for example a defined number of iterations is reached or slope variable β reaches a defined threshold β_{threshold}), logistic function 502 can be replaced with the true quantization function (e.g., a pure step function with a vertical slope section preceded by and followed by horizontal slope sections) for the forward passes of remaining training iterations. In some examples, for these remaining iterations, the backward pass still uses the derivative of the logistic function with the slope variable β held constant (for example at the defined threshold β_{threshold}) for the remaining backward passes.

The gradual quantization process described above can, in at least some scenarios, mitigate against destabilization that can result from too rapid quantization. The gradual quantization process can allow the NN 90 to be slowly guided toward its quantized variant.

In example embodiments, NN 90 can be used to implement NN models for a number of different asks, including for example, for image classification models, Natural Processing Language models, Speech Recognition models, Medical Images Analysis models, and other NN models that have a large number of parameters and pass through a training process to be deployed on computationally constrained devices, for example edge devices such as cellphone, embedded devices, robotic, drone, camera and IoT sensors.

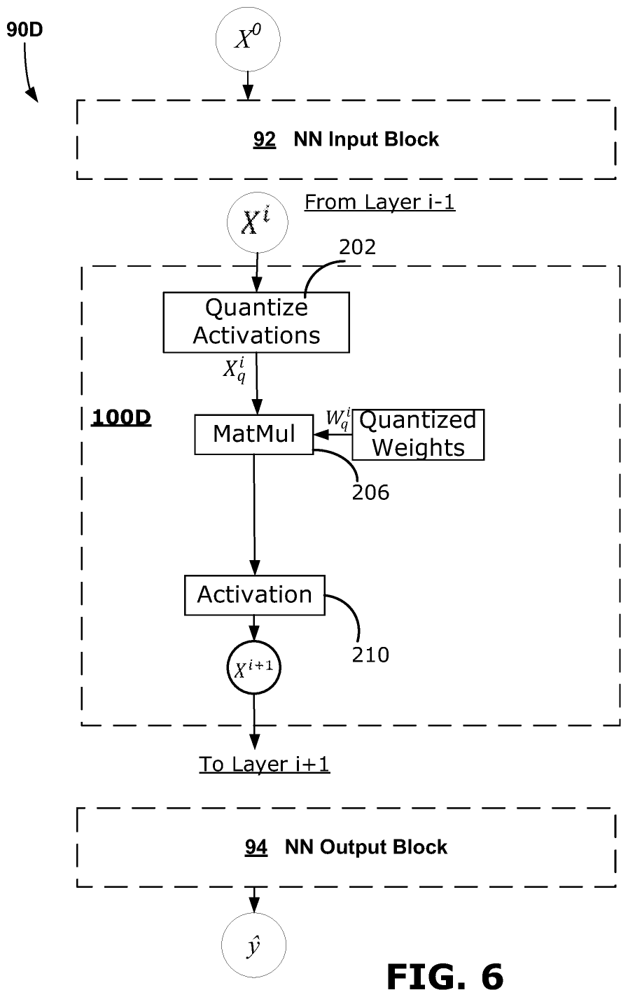

When the NN 90 is deployed for inference purposes, the one or more training stage computational blocks 100i are replaced with respective deployment computational blocks 100D parametrized by quantized weights. An example of a trained and deployed NN 90D version of NN 90 is illustrated in FIG. 6. In the trained and deployed NN 90D, the quantize weights operation 204 is not required as the quantized weights are provided as part of the NN model. Further, the BN operation 208 can be folded into MatMul operation 206.

Training Overview

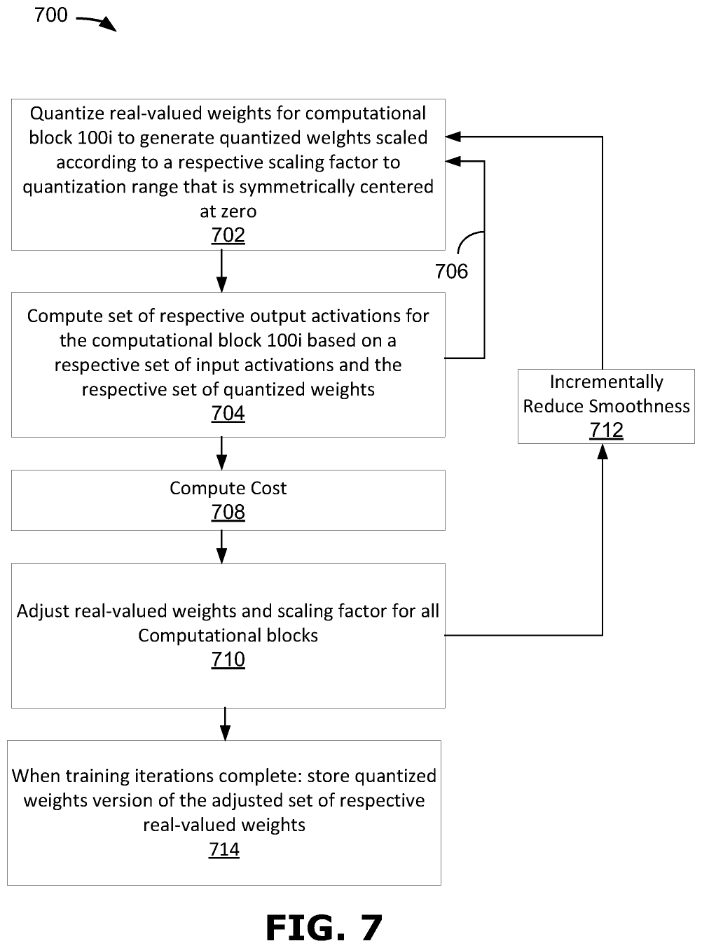

An overview of a method 700 of training of an NN such as NN 90 will now be described with reference to FIG. 7, according to example aspects of this disclosure. The method 700 applies the regularized, constrained and gradual quantization methodologies described above.

Method 700 includes a plurality of training iterations. During a forward pass of each training iteration: (1) as indicated at Block 702, for computational block 100i, quantize weights operation 204 applies a respective quantization function to set of respective real-valued weights W′ of the computational block 100i to generate a respective set of quantized weights W′q that are scaled based on a respective scaling factor α to fall within a respective quantization range that is symmetrically centered at zero and comprises a defined number M of uniform quantization levels corresponding to integer multiples of the respective scaling factor α; and (2) as indicated at Block 704, for computational block 100i, MatMul operation 206, BN operation 208 and activation operation 210 collectively compute a set of respective output activations Xⁱ⁺¹ for the computational block based on a respective set of input activations and the respective set of quantized weights Wⁱ_{q}. As indicated by arrow 706, Blocks 702 and 704 are performed for each of the computational blocks 100i of NN 90.

As indicated at Block 708, a cost for the training iteration is computed by evaluation block 96 based on the respective output activations of the computational blocks and relative alignments of the respective quantized weights of the computational blocks with the uniform quantization levels of the respective quantization ranges.

As indicated at Block 710, during backward pass of the training iteration, the set of respective real-valued weights and the respective scaling factors of each of the computational blocks 100i are adjusted with an objective of reducing the computed cost in one or more following training iterations.

As indicated at Block 612, when performing the plurality of training iterations, a smoothness of the respective quantization functions of the computational blocks is incrementally reduced for multiple training iterations of the plurality of training iterations.

As described above, for each training iteration, for each training iteration, computing the cost comprises applying a scaling factor regularization function to output regularization cost values based on the respective quantized weights and the respective scaling factors, the scaling factor regularization function being configured to generate a regularization cost value that decreases the closer that the respective quantized weights each align with one of the uniform quantization levels. (see for example FIGS. 4A and 4B).

As shown in FIG. 2 the NN 90 comprises input block 92 prior to the plurality of computational blocks, and output block 94 following the plurality of computational blocks 100i, the input block 92, plurality of computational blocks, 100i and output block 94 arranged as respective layers of the NN 90 to collectively process input feature tensors X⁰ received at the input block 92 representing objects and output, from the output block 94, respective predictions ŷ for the objects. For each training iteration, the respective set of input activations for each of the plurality of computational blocks 100i following a first computational block 100₁ is the set of output activations computed by a preceding computation block of the plurality of computational blocks, and each training iteration comprises, for each computational block, applying a respective activation quantization function to the respective set of respective set of input activations to generate a respective set of quantized activations. For each computational block, computing the set of respective output activations for the computational block is based on a matrix multiplication of the respective set of quantized activations and the respective set of quantized weights for the computational block. For each training iteration, computing the cost comprises computing an error between the respective predictions for the objects and expected values for the objects.

As described above and illustrated in FIGS. 5A to 5D, in some examples, the respective quantization functions are each a piecewise function that includes a plurality of repeated, shifted functions that each correspond to a respective uniform quantization level, and in Block 712, reducing the smoothness of the respective quantization functions comprises increasing a slope of the function. adjusting the set of respective real-valued weights and the respective scaling factor for each computational block is performed using a derivative of a corresponding one of the plurality of repeated, shifted functions for at least some of the plurality of training iterations.

In some examples, reducing the smoothness of the respective quantization functions is performed in a linear manner across at least a first group of the plurality of training iterations and Block 712 is suspended when a smoothness criteria is reached, following which a step quantization function is used as the respective quantization functions for a remainder of the plurality of training iterations.

As indicated in Block 714, in some examples, method 700 includes storing, for each of the computational blocks, a quantized weights version of the adjusted set of respective real-valued weights at a completion of the plurality of training iterations, and deploying a trained version 90D of the neural network that includes the quantized weights version for each of the computational blocks.

The NN may be software-implemented by machine readable instructions that are executed using a processing unit, such as a tensor processing unit or a neural processing unit. Alternatively, the NN may be implemented using software that includes machine readable instructions executed by a dedicated hardware device, such as a compact, energy efficient AI chip (e.g. a microprocessor which is specifically designed to execute NN operations tasks faster, using less power than a conventional microprocessor) that includes a small number of logical gates. In example embodiments the NN is trained using a processing unit that is more powerful than the processing systems on which the trained NN is ultimately deployed for inference operations.

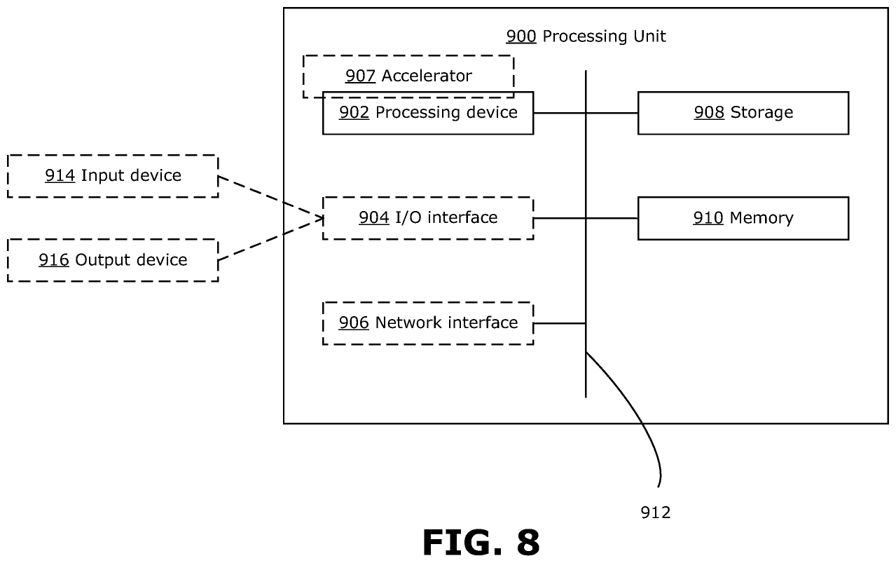

FIG. 8 is a block diagram of an example inference stage hardware device that includes a processing unit 900, which may be used for training purposes to execute the machine executable instructions of a NN 90 that includes one or more training stage computational blocks 100i, or during post-training inference to execute machine executable instructions of a trained NN 90D that includes one or more deployed computational blocks 100D. Other processing unit configurations suitable for implementing embodiments described in the present disclosure may be used, which may include components different from those discussed below. Although FIG. 8 shows a single instance of each component, there may be multiple instances of each component in the processing unit 900.

The processing unit 900 may include one or more processing devices 902, such as a processor, a microprocessor, an application-specific integrated circuit (ASIC), a field-programmable gate array (FPGA), a dedicated logic circuitry, or combinations thereof. In example embodiments, a processing unit 900 that is used for training purposes may include an accelerator 907 connected to the processing device 902. The processing unit 900 may also include one or more input/output (I/O) interfaces 904, which may enable interfacing with one or more appropriate input devices 914 and/or output devices 916. The processing unit 900 may include one or more network interfaces 906 for wired or wireless communication with a network (e.g., an intranet, the Internet, a P2P network, a WAN and/or a LAN) or other node. The network interfaces 906 may include wired links (e.g., Ethernet cable) and/or wireless links (e.g., one or more antennas) for intra-network and/or inter-network communications.

The processing unit 900 may also include one or more storage units 908, which may include a mass storage unit such as a solid state drive, a hard disk drive, a magnetic disk drive and/or an optical disk drive. The processing unit 900 may include one or more memories 910, which may include a volatile or non-volatile memory (e.g., a flash memory, a random access memory (RAM), and/or a read-only memory (ROM)). The non-transitory memory(ies) 910 may store instructions for execution by the processing device(s) 902, such as to carry out examples described in the present disclosure. The memory(ies) 910 may include other software instructions, such as for implementing an operating system and other applications/functions. In some examples, memory 910 may include software instructions for execution by the processing device 902 to implement and train a neural network that includes the computational block 100i of the present disclosure. In some examples, memory 910 may include software instructions and data (e.g., weight and threshold parameters) for execution by the processing device 902 to implement a trained neural network that includes the deployed computational block 100D version of computational block 100i.

In some examples, one or more data sets and/or modules may be provided by an external memory (e.g., an external drive in wired or wireless communication with the processing unit 900) or may be provided by a non-transitory computer-readable medium. Examples of non-transitory computer readable media include a RAM, a ROM, an erasable programmable ROM (EPROM), an electrically erasable programmable ROM (EEPROM), a flash memory, a CD-ROM, or other portable memory storage.

There may be a bus 912 providing communication among components of the processing unit 900, including the processing device(s) 902, I/O interface(s) 904, network interface(s) 906, storage unit(s) 908 and/or memory(ies) 910. The bus 912 may be any suitable bus architecture including, for example, a memory bus, a peripheral bus or a video bus.

Although the present disclosure describes methods and processes with steps in a certain order, one or more steps of the methods and processes may be omitted or altered as appropriate. One or more steps may take place in an order other than that in which they are described, as appropriate. As used herein, statements that a first item (e.g., a signal, tensor, array, variable, value, scalar, vector, matrix, calculation, or bit sequence) is “based on” a second item can mean that characteristics of the first item are affected or determined at least in part by characteristics of the second item. The second item can be considered an input to an operation or calculation, or a series of operations or calculations that produces the first item as an output that is not independent from the second item.

Although the present disclosure is described, at least in part, in terms of methods, a person of ordinary skill in the art will understand that the present disclosure is also directed to the various components for performing at least some of the aspects and features of the described methods, be it by way of hardware components, software or any combination of the two. Accordingly, the technical solution of the present disclosure may be embodied in the form of a software product. A suitable software product may be stored in a pre-recorded storage device or other similar non-volatile or non-transitory computer readable medium, including DVDs, CD-ROMs, USB flash disk, a removable hard disk, or other storage media, for example. The software product includes instructions tangibly stored thereon that enable a processing device (e.g., a personal computer, a server, or a network device) to execute examples of the methods disclosed herein.

The present disclosure may be embodied in other specific forms without departing from the subject matter of the claims. The described example embodiments are to be considered in all respects as being only illustrative and not restrictive. Selected features from one or more of the above-described embodiments may be combined to create alternative embodiments not explicitly described, features suitable for such combinations being understood within the scope of this disclosure.

All values and sub-ranges within disclosed ranges are also disclosed. Also, although the systems, devices and processes disclosed and shown herein may comprise a specific number of elements/components, the systems, devices and assemblies could be modified to include additional or fewer of such elements/components. For example, although any of the elements/components disclosed may be referenced as being singular, the embodiments disclosed herein could be modified to include a plurality of such elements/components. The subject matter described herein intends to cover and embrace all suitable changes in technology.

1. A method of training a neural network that comprises a plurality of computational blocks, comprising:
performing a plurality of training iterations, each training iteration comprising:
for each computational block, applying a respective quantization function to a set of respective real-valued weights of the computational block to generate a respective set of quantized weights that are scaled based on a respective scaling factor to fall within a respective quantization range that is symmetrically centered at zero and comprises a defined number of uniform quantization levels corresponding to integer multiples of the respective scaling factor,
for each computational block, computing a set of respective output activations for the computational block based on a respective set of input activations and the respective set of quantized weights,
computing a cost for the training iteration based on the respective output activations of the computational blocks and relative alignments of the respective quantized weights of the computational blocks with the uniform quantization levels of the respective quantization ranges, and
for each computational block, adjusting the set of respective real-valued weights and the respective scaling factor with an objective of reducing the computed cost in one or more following training iterations; and
when performing the plurality of training iterations, incrementally reducing a smoothness of the respective quantization functions applied by the computational blocks for multiple training iterations of the plurality of training iterations.

2. The method of claim 1 wherein, for each training iteration, computing the cost comprises applying a scaling factor regularization function to output regularization cost values based on the respective quantized weights and the respective scaling factors, the scaling factor regularization function being configured to generate a regularization cost value that decreases the closer that the respective quantized weights each align with one of the uniform quantization levels.

3. The method of claim 2 wherein the neural network comprises an input block prior to the plurality of computational blocks, and an output block following the plurality of computational blocks, the input block, plurality of computational blocks, and output block arranged as respective layers of the neural network to collectively process input feature tensors received at the input block representing objects and output, from the output block, respective predictions for the objects, and
wherein, for each training iteration, the respective set of input activations for each of the plurality of computational blocks following a first computational block is the set of output activations computed by a preceding computation block of the plurality of computational blocks, and each training iteration comprises, for each computational block, applying a respective activation quantization function to the respective set of respective set of input activations to generate a respective set of quantized activations, wherein for each computational block, computing the set of respective output activations for the computational block is based on a matrix multiplication of the respective set of quantized activations and the respective set of quantized weights for the computational block;
wherein, for each training iteration, computing the cost comprises computing an error between the respective predictions for the objects and expected values for the objects.

4. The method of claim 3 wherein, for each computational block, applying the respective activation quantization function generates the respective set of quantized activations scaled within a respective activation quantization range that is symmetrically centered at zero and comprises a defined number of uniform activation quantization levels.

5. The method of claim 1 wherein the computational blocks include at least one computational block that implements one of a fully connected neural network layer or a convolution neural network layer.

6. The method of claim 1 wherein for each computational block, the respective quantization function is a piecewise function comprising a plurality of repeated, shifted functions that each correspond to a respective uniform quantization level, and wherein incrementally reducing the smoothness of the respective quantization functions comprises incrementally increasing a slope of the function.

7. The method of claim 6 wherein adjusting the set of respective real-valued weights and the respective scaling factor for each computational block is performed using a derivative of a corresponding one of the plurality of repeated, shifted functions for at least some of the plurality of training iterations.

8. The method of claim 6 wherein incrementally reducing the smoothness of the respective quantization functions is performed in a linear manner across at least a first group of the plurality of training iterations and is suspended when a predetermined criteria is reached, following which a quantization function of constant smoothness is used as the respective quantization functions for a remainder of the plurality of training iterations.

9. The method of claim 1 wherein the defined number of uniform quantization levels is 15.

10. The method of claim 1 further comprising storing, for each of the computational blocks, a quantized weights version of the adjusted set of respective real-valued weights at a completion of the plurality of training iterations, and deploying a trained version of the neural network that includes the quantized weights version for each of the computational blocks.

11. A processing unit, comprising:
one or more processing devices;
one or more storages operatively connected to the one or more processing devices and storing executable instructions that when executed by the one or more processing devices configure the processing unit to perform a method comprising:
performing a plurality of training iterations for a neural network, each training iteration comprising:
for each computational block, applying a respective quantization function to a set of respective real-valued weights of the computational block to generate a respective set of quantized weights that are scaled based on a respective scaling factor to fall within a respective quantization range that is symmetrically centered at zero and comprises a defined number of uniform quantization levels corresponding to integer multiples of the respective scaling factor,
for each computational block, computing a set of respective output activations for the computational block based on a respective set of input activations and the respective set of quantized weights,
computing a cost for the training iteration based on the respective output activations of the computational blocks and relative alignments of the respective quantized weights of the computational blocks with the uniform quantization levels of the respective quantization ranges, and
for each computational block, adjusting the set of respective real-valued weights and the respective scaling factor with an objective of reducing the computed cost in one or more following training iterations; and
when performing the plurality of training iterations, incrementally reducing a smoothness of the respective quantization functions applied by the computational blocks for multiple training iterations of the plurality of training iterations.

12. The processing unit of claim 11 wherein the method performed by the processing unit comprises: for each training iteration, computing the cost comprises applying a scaling factor regularization function to output regularization cost values based on the respective quantized weights and the respective scaling factors, the scaling factor regularization function being configured to generate a regularization cost value that decreases the closer that the respective quantized weights each align with one of the uniform quantization levels.

13. The processing unit of claim 12 wherein the neural network comprises an input block prior to the plurality of computational blocks, and an output block following the plurality of computational blocks, the input block, plurality of computational blocks, and output block arranged as respective layers of the neural network to collectively process input feature tensors received at the input block representing objects and output, from the output block, respective predictions for the objects, and
wherein, for each training iteration, the respective set of input activations for each of the plurality of computational blocks following a first computational block is the set of output activations computed by a preceding computation block of the plurality of computational blocks, and each training iteration comprises, for each computational block, applying a respective activation quantization function to the respective set of respective set of input activations to generate a respective set of quantized activations, wherein for each computational block, computing the set of respective output activations for the computational block is based on a matrix multiplication of the respective set of quantized activations and the respective set of quantized weights for the computational block;
wherein, for each training iteration, computing the cost comprises computing an error between the respective predictions for the objects and expected values for the objects.

14. The processing unit of claim 13 wherein, for each computational block, applying the respective activation quantization function generates the respective set of quantized activations scaled within a respective activation quantization range that is symmetrically centered at zero and comprises a defined number of uniform activation quantization levels.

15. The processing unit of claim 11 wherein the computational blocks include at least one computational block that implements one of a fully connected neural network layer or a convolution neural network layer.

16. The processing unit of claim 11 wherein for each computational block, the respective quantization function is a piecewise function comprising a plurality of repeated, shifted functions that each correspond to a respective uniform quantization level, and wherein incrementally reducing the smoothness of the respective quantization functions comprises incrementally increasing a slope of the function.

17. The processing unit of claim 16 wherein adjusting the set of respective real-valued weights and the respective scaling factor for each computational block is performed using a derivative of a corresponding one of the plurality of repeated, shifted functions for at least some of the plurality of training iterations.

18. The processing unit of claim 16 wherein incrementally reducing the smoothness of the respective quantization functions is performed in a linear manner across at least a first group of the plurality of training iterations and is suspended when a predetermined criteria is reached, following which a quantization function of constant smoothness is used as the respective quantization functions for a remainder of the plurality of training iterations.

19. The processing unit of claim 11 wherein the method performed by the processing unit comprises: storing, for each of the computational blocks, a quantized weights version of the adjusted set of respective real-valued weights at a completion of the plurality of training iterations, and deploying a trained version of the neural network that includes the quantized weights version for each of the computational blocks.

20. A non-transitory computer readable medium that stores computer program instructions for configuring a processing unit to perform a method comprising:
performing a plurality of training iterations, each training iteration comprising:
for each computational block, applying a respective quantization function to a set of respective real-valued weights of the computational block to generate a respective set of quantized weights that are scaled based on a respective scaling factor to fall within a respective quantization range that is symmetrically centered at zero and comprises a defined number of uniform quantization levels corresponding to integer multiples of the respective scaling factor,
for each computational block, computing a set of respective output activations for the computational block based on a respective set of input activations and the respective set of quantized weights,
computing a cost for the training iteration based on the respective output activations of the computational blocks and relative alignments of the respective quantized weights of the computational blocks with the uniform quantization levels of the respective quantization ranges, and
for each computational block, adjusting the set of respective real-valued weights and the respective scaling factor with an objective of reducing the computed cost in one or more following training iterations; and
when performing the plurality of training iterations, incrementally reducing a smoothness of the respective quantization functions applied by the computational blocks for multiple training iterations of the plurality of training iterations.
